(19) United States
(12) Patent Application Publication
(10) Pub. No.: US 2007/0089145 A1
(43) Pub. Date: Apr. 19, 2007

(54) System and method of delivering video data

(75) Inventors: Brad Allen Medford, Austin, TX (US); David Allen Deas, Round Rock, TX (US); David Randall Wolter, Austin, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/253,297

(22) Filed: Oct. 18, 2005

(51) Int. Cl. H04N 7/18; H04N 7/173; H04N 7/16

(52) U.S. Cl. 725/81; 725/110; 725/112; 725/133; 725/141

(57) ABSTRACT

The present disclosure is directed to a system and method to deliver video data. The method can include selectively transmitting a low data rate video stream to at least one display device. The method can also include generating a mirror video stream that is derived from the low data rate video stream, where the mirror video stream has a data rate compatible with at least one wireless network. The method can also include selectively transmitting the mirror video stream to at least one wireless device via the at least one wireless network.

### FIELD OF THE DISCLOSURE

The present disclosure relates generally to delivering video data.

### BACKGROUND

Wireless communication provides a convenient source of information for many individuals. People can exchange messages, have conversations, and transmit photographs using portable wireless devices, such as cellular phones and laptop computers. The mobility of wireless technologies enables users to receive telephone and electronic communications in many settings. Thus, users are free to conduct activities outside of a home or office while staying in contact with others.

As wireless communication has become prevalent, the number of services that are available to wireless users has increased. For example, in addition to communicating with people, cell phone users can access information via the Internet and even manipulate remote systems. Nonetheless, current technologies generally fail to provide users with access to video data, such as television content, via wireless devices.

### BRIEF DESCRIPTION OF THE DRAWINGS

FIG. 1 is a block diagram illustrating an embodiment of a video delivery system;

FIG. 2 is a flow diagram illustrating an embodiment of a method of delivering video data;

FIG. 3 is a flow diagram illustrating an embodiment of a method of delivering video data;

FIG. 4 is a flow diagram illustrating an embodiment of a method of delivering video data;

FIG. 5 is a flow diagram illustrating a method of receiving video data; and

FIG. 6 is a diagram of one embodiment of a general computer system.

### DETAILED DESCRIPTION OF THE DRAWINGS

A system to deliver video data is disclosed and includes a switch having a processor and a memory accessible to the processor. A computer program is embedded in the memory and can include instructions to receive a first video stream having a first data rate. The computer program can also include instructions to generate a second video stream that is a mirror of the first video stream and has a second data rate that is substantially the same as the first data rate, where the second data rate is compatible with at least one wireless network.

In another embodiment, a method of delivering video data is disclosed. The method can include selectively transmitting a low data rate video stream to at least one display device. The method can also include generating a mirror video stream that is derived from the low data rate video stream, where the mirror video stream has a data rate compatible with at least one wireless network. The method can also include selectively transmitting the mirror video stream to at least one wireless device via the at least one wireless network.

In another embodiment, a method of receiving video data is disclosed and includes receiving a request for a video stream from a wireless device. The method also includes obtaining subscriber information of the wireless device from an information store. The method also includes receiving a mirror video stream, wherein the mirror video stream is reproduced from a low data rate video stream transmitted to at least one display device. The method also includes selectively transmitting the mirror video stream to the wireless device.

In another embodiment, a method of receiving video data is disclosed and includes receiving a mirror video stream at a wireless device via a wireless network. The mirror video stream is mirrored from a low data rate video stream transmitted to a display device. The data rate of the low data rate video stream comprises a data rate of the wireless network.

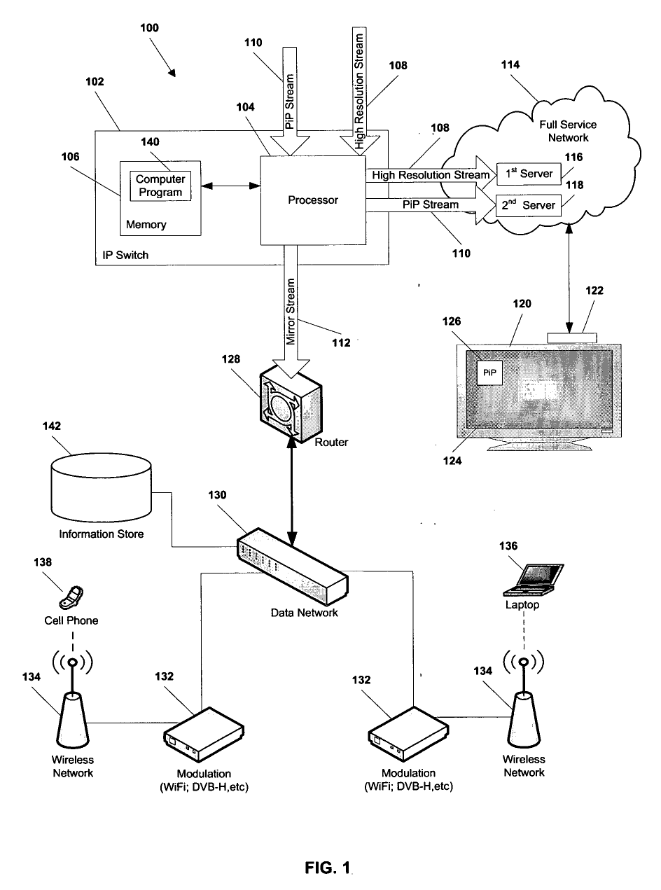

Referring to FIG. 1, a system to deliver video data is shown and is generally designated 100. As shown, the system 100 includes a switch device 102. The switch device 102 includes a processor 104 and a memory device 106 that is accessible to the processor 104. The switch device 102 communicates with at least one display device, e.g., at least one television monitor 120. In a particular embodiment, the television monitor 120 has a main display area 124 and a secondary display area 126. In an illustrative embodiment, the secondary display area 126 can be a picture-in-picture (PiP) display area.

In an illustrative embodiment, the switch device 102 can be an Internet protocol (IP) switch. In a particular embodiment, the switch device 102 can communicate with the television monitor 120 via a full service network 114 that has at least a first server 116 and a second server 118. Further, in a particular embodiment, the television monitor 120 can communicate with the full service network 114 using a set-top box device 122.

As indicated in FIG. 1, the switch 102 is also coupled to a router 128. The router 128 communicates with one or more wireless network access points 134. In a particular embodiment, the router 128 can communicate with the wireless network access points 134 through a data network 130. Further, in a particular embodiment, the router 128 can also be coupled to one or more modulators 132 via the data network 130. In an illustrative embodiment, the modulators 132 may modulate signals from the router 128. For example, the modulator 132 can modulate the signals from an initial frequency to a frequency of a cellular network, an 802.11x network, a DVB-H network, or any other wireless network that communicates data to wireless devices over a particular frequency or range of frequencies.

In a particular embodiment of the disclosed system 100, as depicted in FIG. 1, the switch 102 can receive a high data rate video stream 108 and a picture-in-picture (PiP) stream 110 from one or more television content providers or broadcast services. In a particular embodiment, the PiP stream can be a low data rate video stream. Further, the switch 102 can communicate the PiP video stream 110 and the high data rate video stream 108 to the full service network 114. In this particular embodiment, the PiP stream 110 can be a low data rate video stream 110 that has a data rate that is equivalent to or within the range of frequencies that are compatible with one or more of the wireless network access points 134.

In an illustrative embodiment, the high data rate video stream 108 is communicated to the first server 116 on the full service network 114, and the low data rate video stream 110 is communicated to a second server 118 on the full service network 114. In a particular embodiment, the first server 116 and the second server 118 have separate IP addresses. Moreover, in an illustrative embodiment, the set-top box device 122 can retrieve the high data rate video stream 108 from the first server 116 using the IP address associated with the first server 116. Also, the set-top box device 122 can transmit the high data rate video stream 108 to the television monitor 120 for display in the main display area 124 of the television monitor 120. Further, the set-top box device 122 can retrieve the PiP video stream 110, such as when requested by a viewer, from the second server 118 using the IP address associated with the second server 118. Also, the set-top box device 122 can transmit the PiP video stream 110 to the television monitor 120 for display in the secondary display area 126 of the television monitor 120.

As indicated in FIG. 1, the IP switch 102 includes a computer program 140 embedded within the memory device 106. In a particular embodiment, the computer program 140 can contain instructions to reproduce the PiP stream 110 to generate a mirror video stream 112. In an illustrative embodiment, the mirror video stream 112 is a replication of the PiP video stream 110. The mirror video stream 112 can be communicated to at least one wireless device, such as a cell phone 138 or a laptop computer 136. In an illustrative embodiment, as shown in FIG. 1, the mirror video stream 112 can be communicated via the router 128 to the data network 130, where the frequency of the mirror video stream 112 is modulated by one or more modulators 132, to the frequency of one or more wireless network access points 134.

In a particular embodiment, the system 100 can also include an information store 142. Further, in a particular embodiment, a request for video content can be received at the data network 130 from a wireless device 136, 138. The data network 130 can query the information store 142 for subscriber information that corresponds to the wireless device 136, 138 that issued the request. If the information store 142 contains such subscriber information, and the wireless device 136, 138 is authenticated, the mirror video stream 112 can be communicated to the requesting wireless device. If the information store 142 does not contain such subscriber information, the mirror video stream 112 is not communicated to the requesting wireless device.

In a particular embodiment, the PiP stream 10 may include video data or both video and audio data, such as television content. Also, the mirror video stream 112 can include video data or both video and audio data, such as television content. Additionally, in a particular embodiment, the computer program 140 can include instructions to filter out particular video and audio content that is not intended to be sent to the wireless network access points 134.

In a particular embodiment, the IP switch 102 can be located at a service provider premises that serves a viewing area, such as a metropolitan area. In this embodiment, local television content customarily shown in the viewing area is maintained. Additionally, the service provider can also maintain the full service network 114, and all servers 116, 118 associated therewith, at the premises to serve the particular viewing area. Thus, network traffic can be more easily estimated and accommodated. In an illustrative embodiment, each data network 130 can be maintained locally, regionally, nationally or globally, corresponding to the location of systems or wireless network access points 134 used by wireless carriers to provide service. Though a single data network 130 is shown as an example, multiple data networks may be used with multiple wireless carriers.

The system 100 can include a variety of wireless access technologies and networks. Such wireless access technologies and networks can include a variety of frequencies and modulation methods. In one embodiment, wireless networks associated with wireless network access points 134 can include broadcast type networks that broadcast television content via ultra-high frequency (UHF) or very-high frequency (VHF) bands. Additionally, broadcast networks associated with wireless network access points 134 can include digital video broadcasting-handheld (DVB-H) networks or other media distribution systems, such as MediaFLO™. In an illustrative, non-limiting embodiment, the system 100 can communicate via the wireless network access points 134 with DVB-H and MediaFLO™ networks that provide a media throughput of approximately 300 Kbps and operate in the 1700 MHz and 700 MHz bands, respectively.

In another embodiment, wireless networks associated with wireless network access points 134 can include cellular or personal communication service (PCS) networks, such as those based on Time Division Multiple Access (TDMA) technologies, Global System for Mobile communication (GSM) technologies, General Packet Radio System (GPRS) technologies, Enhanced Data GSM Environment (EDGE) technologies, Universal Mobile Telephone Service (UMTS) technologies, High Speed Downlink Packet Access (HSDPA) technologies, code-division multiple access (CDMA), wideband CDMA, or Evolution Data Only or Evolution Data Optimized (collectively, EV-DO or 1XEV-DO) technologies, or any combination thereof, such as GPRS/EDGE or UMTS/HSDPA technologies. In an illustrative, non-limiting embodiment, the system 100 can communicate via the wireless network access points 134 with TDMA, UMTS, HSDPA, or 1xEV-DO networks that transmit packet data at several hundred kilobits (200 Kbps) per second to more than one megabit per second (1 Mbps) and operate in cellular (850 MHz) and PCS (1900 MHz) bands.

In another embodiment, wireless networks associated with wireless network access points 134 can include wireless fidelity (WiFi) networks that use 802.11 specifications, or broadband wireless access (WiMax) networks that use 802.16 specifications. For example, hotspots, home networks and enterprise networks based on WiFi technologies may be used for transport of the mirror video stream 112 to the laptop 136. In a particular embodiment, the system 100 can communicate via the wireless network access points 134 with a WiFi network that transmits data at faster than one megabit per second (1 Mbps) and operate in the unlicensed 2.4 GHz or 5.8 GHz bands.

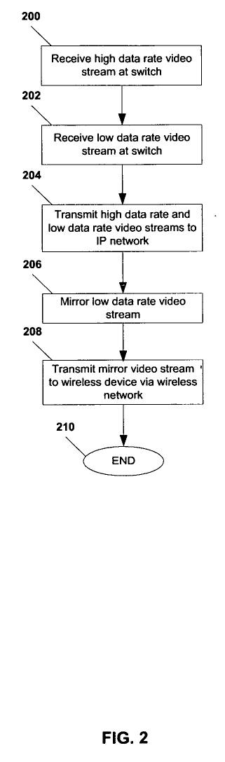

Referring to FIG. 2, a method of delivering video data is shown. At block 200, a high data rate video stream is received at an Internet protocol (IP) switch. At block 202, a low data rate video stream is received at the IP switch. In an illustrative embodiment, the low data rate video stream can be a picture-in-picture video stream. Moving to block 204, the high data rate video stream and the low data rate video stream are transmitted from the IP switch to a full service network, such as an Internet protocol (IP) network.

In a particular embodiment, the high data rate video stream can be selectively retrieved by a set-top box device at a first IP address and communicated to a television monitor. Further, the low data rate video stream can be selectively retrieved by the set-top box device at a second Internet protocol address and communicated to a picture-in-picture (PiP) area of the television monitor.

Moving to block 206, the low data rate video stream is reproduced to generate a mirror video stream that is derived from the low data rate video stream. In a particular embodiment, the mirror video stream can comprise video and audio data. In another particular embodiment, the mirror video stream can comprise only video data. In an illustrative embodiment, the mirror video stream can include television content.

At block 208, the mirror video stream is selectively transmitted to one or more wireless devices via one or more wireless networks. In a particular embodiment, the mirror video stream can be reformatted to a format that is compatible with the wireless network(s). Additionally, a frequency of the mirror video stream can be modulated to a frequency compatible with the wireless network(s). The method ends at 210.

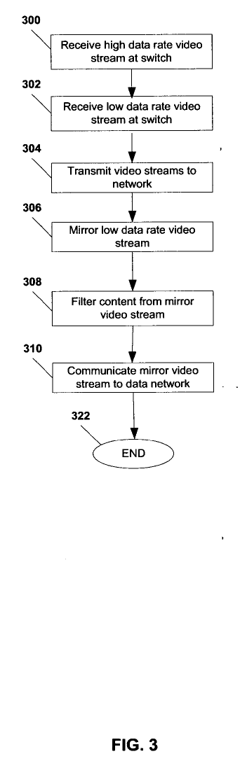

Referring to FIG. 3, an embodiment of a method of delivering video data is shown. At block 300, a high data rate video stream is received at an Internet protocol (IP) switch. At block 302, a low data rate video stream is received at the IP switch. In an illustrative embodiment, the low data rate video stream can be a picture-in-picture (PiP) video stream. Moving to block 304, the high data rate video stream and the low data rate video stream are transmitted from the IP switch to an Internet protocol (IP) network.

Moving to block 306, the low data rate video stream is reproduced to generate a mirror video stream that is derived from the low data rate video stream. In a particular embodiment, the mirror video stream can comprise video and audio data.

As shown at block 308, content can be filtered from the mirror video stream. For example, certain channels of television content can be filtered out of the mirror video stream, if they are not intended to be transmitted to the wireless networks. Alternatively, only certain channels that are intended to be transmitted to the wireless networks, such as television weather content, can be filtered from the mirror video stream for transmission to the wireless networks.

In a particular embodiment, as shown at block 310, the mirror video stream can be communicated to a data network, such as via a router, and can then be communicated over a wireless network.

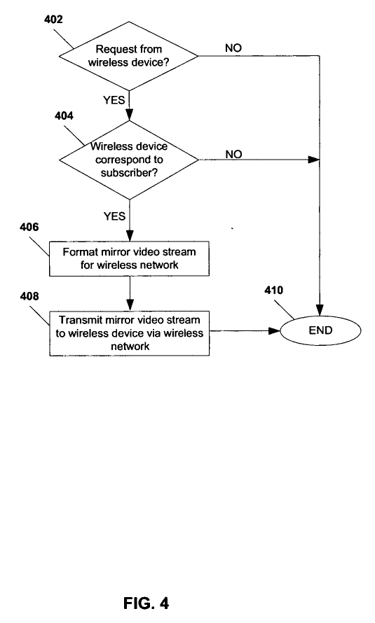

Referring to FIG. 4, a particular embodiment of delivering video data is shown. At decision step 402, it is determined whether a request has been received for video content, such as a television program. If no such request has been received, the method ends at 410. If such a request is received, for example at a data network, then the method proceeds to decision step 404. At decision step 404, it is determined whether an information store contains subscriber information corresponding to the wireless device that issued the request. If the information store contains such subscriber information, and the wireless device is authenticated, the method proceeds to block 406. If the information store does not contain such subscriber information, then the method ends at 410.

Moving to block 406, if video content has been requested by a wireless device, and subscriber information corresponding to the wireless device has been verified, a mirror video stream can be formatted to be compatible with the wireless network to communicate to the requesting device. In a particular embodiment, as described herein, the mirror video stream can be received from an IP switch and can be derived from a replication of a low data rate video stream transmitted to a display device.

Moving to block 408, the mirror video stream is selectively transmitted to one or more requesting wireless devices via the wireless network(s) that carry data to each device. The method terminates at 410.

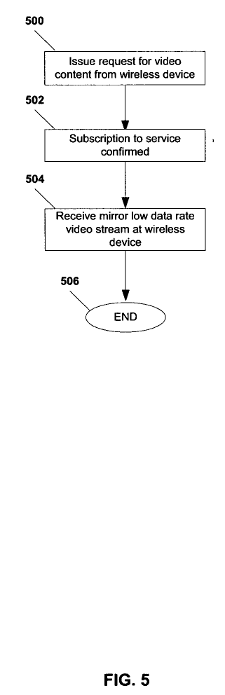

Referring to FIG. 5, a method of receiving video data is shown. At block 500, the method includes issuing a request for video content from a wireless device. For example, a user can issue a request from a cellular phone or laptop computer having access to a wireless data network. At block 502, subscription information corresponding to the wireless device is confirmed. In a particular embodiment, a data network can query an information store to confirm the subscription information. Once a subscription corresponding to the wireless device is confirmed, a mirror video stream derived from a low data rate broadcast video stream is received at the wireless device, as shown at block 504. The method terminates at 506.

In a particular embodiment, the steps of the methods described herein are executed in the order shown by the figures. In alternative embodiments, the steps may be executed in alternative sequences. For example, in the methods shown by FIGS. 2 and 3, the high data rate and low data rate video streams can be received in any sequence or simultaneously.

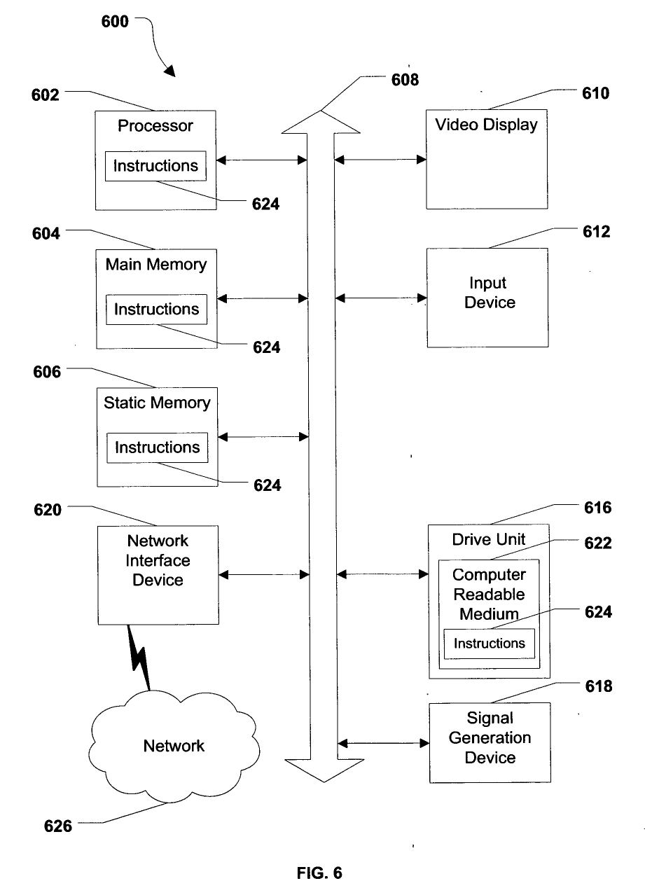

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600, or any portion thereof, may operate as a standalone device or may be connected, e.g., using a network, to other computer systems or peripheral devices or may be embedded within an Internet Protocol switch, as shown in FIG. 1.

In a networked deployment, the computer system may operate in the capacity of an IP switch, e.g., IP switch 102 in FIG. 1, that processes and transmits video streams, or as a client user computer in a server-client user network environment, or as a peer computer system in a peer-to-peer (or distributed) network environment. The computer system 600 can also be implemented as or incorporated into various devices that are incorporated with or peripheral to the system shown in FIG. 1, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, keypad, touch-tone keys, cursor control keys (including, but not limited to cursor control keys on a wireless phone or other wireless device) or mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In conjunction with the configuration of structure described herein, the system and method disclosed deliver video content, such as television content, to wireless devices without requiring specialized equipment, such as “diversity” antennae and the like. The low data rate PiP stream saves bandwidth on the full service network, and its reproduction provides compatibility with one or more wireless network. Modulation or reformatting equipment may be used to alter other properties of the mirror video stream for compatibility with the wireless network(s).

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of delivering video data, the method comprising:
selectively transmitting a low data rate video stream to at least one display device;
generating a mirror video stream that is derived from the low data rate video stream, wherein the mirror video stream has a data rate compatible with at least one wireless network; and
selectively transmitting the mirror video stream to at least one wireless device via the at least one wireless network.

2. The method of claim 1, wherein the at least one display device comprises at least one television monitor.

3. The method of claim 1, further comprising transmitting a high data rate video stream to the at least one display device.

4. The method of claim 3, wherein the low data rate video stream and the high data rate video stream are transmitted to the at least one display device via a full service network.

5. The method of claim 4, wherein the high data rate video stream is transmitted to a first server having a first Internet protocol address of the full service network and the low data rate video stream is transmitted to a second server having a second Internet protocol address of the full service network.

6. The method of claim 1, wherein the low data rate video stream is a picture-in-picture video stream that is displayed in a picture-in-picture region at the at least one display device.

7. The method of claim 1, wherein the mirror video stream comprises video and audio data.

8. The method of claim 7, wherein the low data rate video stream comprises video data.

9. The method of claim 1, wherein the mirror video stream comprises television content.

10. The method of claim 9, further comprising filtering the mirror video stream to remove at least a portion of the television content.

11. The method of claim 1, wherein the mirror video stream is substantially the same as the low data rate video stream.

12. A method of communicating video data, the method comprising:
receiving a request for a video stream from a wireless device;
obtaining subscriber information of the wireless device from an information store;
receiving a mirror video stream, wherein the mirror video stream is reproduced from a low data rate video stream transmitted to at least one display device; and
selectively transmitting the mirror video stream to the wireless device.

13. The method of claim 12, further comprising determining that the wireless device corresponds to a subscriber of a service.

14. The method of claim 12, wherein the at least one display device comprises at least one television monitor.

15. The method of claim 12, further comprising reformatting the mirror video stream to a format compatible with the at least one wireless network prior to transmitting the mirror video stream to the wireless device.

16. A method of receiving video data, the method comprising:
receiving a mirror video stream at a wireless device via a wireless network;
wherein the mirror video stream is mirrored from a low data rate video stream transmitted to a display device; and
wherein a data rate of the low data rate video stream comprises a data rate of the wireless network.

17. The method of claim 16, wherein the mirror video stream comprises television content.

18. The method of claim 16, wherein the mirror video stream is transmitted over the wireless network via a modulated frequency signal and wherein the modulated frequency signal has been converted from an initial frequency signal.

19. The method of claim 16, wherein the mirror video stream is routed to the wireless network via a data network.

20. A system to transmit video data, the system comprising:
a switch having a processor and a memory accessible to the processor; and
a computer program embedded in the memory, the computer program comprising:
instructions to receive a first video stream having a first data rate; and
instructions to generate a second video stream that is a mirror of the first video stream and has a second data rate that is substantially the same as the first data rate, wherein the second data rate is compatible with at least one wireless network.

21. The system of claim 20, wherein the computer program further comprises instructions to selectively transmit the first video stream to at least one display device.

22. The system of claim 20, wherein the computer program further comprises instructions to selectively transmit the second video stream to at least one wireless device, via at least one wireless network.

23. The system of claim 22, wherein the at least one wireless network comprises at least one network selected from a group consisting of a broadcast network, a cellular network, a personal communication service network, a mobile phone network, a digital video broadcasting-handhelds (DVB-H) network, an 802.11x network, and an 802.16x network.

24. The system of claim 20, wherein the computer program further comprises instructions to transmit a high data rate video stream to at least one display device.

25. The system of claim 24, wherein the computer program further comprises instructions to transmit the first video stream and the high data rate data stream to a full service network.

26. The system of claim 24, wherein the computer program further comprises instructions to communicate the high data rate video stream to a first server having a first Internet protocol address of the full service network and the first video stream to a second server having a second Internet protocol address of the full service network.

27. The system of claim 20, wherein the switch communicates with a data network and wherein the computer program further comprises instructions to transmit the second video stream to the data network.

28. The system of claim 27, wherein the data network receives a request for a video stream from a wireless device and authenticates the wireless device before transmitting the second video stream to the wireless device via at least one wireless network.

29. The system of claim 20, further comprising at least one modulator, wherein the at least one modulator modulates an initial frequency signal of the second video stream to a modulated frequency signal.

30. The system of claim 20, further comprising a filter to selectively remove a portion of content.

31. A computer program embedded in a computer-readable medium, the computer program comprising:
instructions to receive a first video stream having a first data rate; and
instructions to generate a second video stream that is a mirror of the first video stream and has a second data rate that is substantially the same as the first data rate, wherein the second data rate is compatible with at least one wireless network.
